(19) United States
(12) Patent Application Publication
(10) Pub. No.: US 2013/0158793 A1
(43) Pub. Date: Jun. 20, 2013

(54) APPARATUS FOR DETECTING START-UP OF A VEHICLE AND FOR CONTROLLING AN EXTERNAL DEVICE

(71) Applicant: Quan Mei Technology Co., Ltd., Tainan City (TW)

(72) Inventors: Kuo-Hsien Huang, Tainan City (TW); Hsiu-Ming Chang, Kaohsiung City (TW)

(73) Assignee: Quan Mei Technology Co., Ltd., Tainan City (TW)

(21) Appl. No.: 13/687,049

(22) Filed: Nov. 28, 2012

(30) Foreign Application Priority Data
Dec. 6, 2011 (TW) 100222997

(51) Int. Cl. B60Q 1/00

(52) U.S. Cl. CPC B60Q 1/00
USPC 701/36

(57) ABSTRACT

An apparatus for detecting start-up of a vehicle and for controlling an external device includes a detecting unit and a control unit. The detecting unit is to be electrically connected to a battery of the vehicle for obtaining information associated with a voltage of the battery. The control unit is electrically connected between the detecting unit and the external device, and is configured to determine whether the vehicle has started up with reference to the information obtained by the detecting unit, and to generate a working signal for triggering the external device upon detecting that the vehicle has started up.

### CROSS-REFERENCE TO RELATED APPLICATION

This application claims priority of Taiwanese application no. 100222997, filed on Dec. 6, 2011.

### BACKGROUND OF THE INVENTION

1. Field of the Invention

This invention relates to a control apparatus, more particularly to an apparatus for detecting start-up of a vehicle and for controlling an external device.

2. Description of the Related Art

In order to improve driving safety and facilitate a driver in discerning other vehicles for keeping a safe following distance, some regulations require that a vehicle be provided with a daytime running light (DRL) that has to be switched on when the vehicle is moving in daytime.

However, the driver may forget to switch on the daytime running light under a well vision and unintentionally violate the regulations.

Further, in general, the daytime running light has to be assembled with an ignition switch of a vehicle. Since ignition switches different in position from vehicle to vehicle, it may be difficult to locate the ignition switch and increase the time spent in mounting the daytime running light.

### SUMMARY OF THE INVENTION

Therefore, the object of the present invention is to provide an apparatus that can detect start-up of a vehicle and that controls an external device, such as a daytime running light, based upon the result of the detection.

According to this invention, an apparatus is configured for detecting start-up of a vehicle and for controlling an external device. The apparatus is adapted to be electrically connected between a battery of the vehicle and the external device, and includes a detecting unit and a control unit. The detecting unit is adapted to be electrically connected to the battery of the vehicle for obtaining information associated with a voltage of the battery. The control unit is electrically connected between the detecting unit and the external device. The control unit is configured to determine whether the vehicle has started up with reference to the information obtained by the detecting unit, and to generate a working signal for triggering the external device upon detecting that the vehicle has started up.

### BRIEF DESCRIPTION OF THE DRAWINGS

Other features and advantages of the present invention will become apparent in the following detailed description of the preferred embodiment of this invention, with reference to the accompanying drawings, in which:

FIG. 1 is a block diagram of the preferred embodiment of an apparatus for detecting start-up of a vehicle and for controlling an external device according to this invention, showing the apparatus connected to the battery and the external device in a way that the apparatus operates under a basic mode; and

FIG. 2 is another block diagram of the preferred embodiment, showing the apparatus connected to the battery and the external device in a way that the apparatus operates under a function selecting mode.

### DETAILED DESCRIPTION OF THE PREFERRED EMBODIMENT

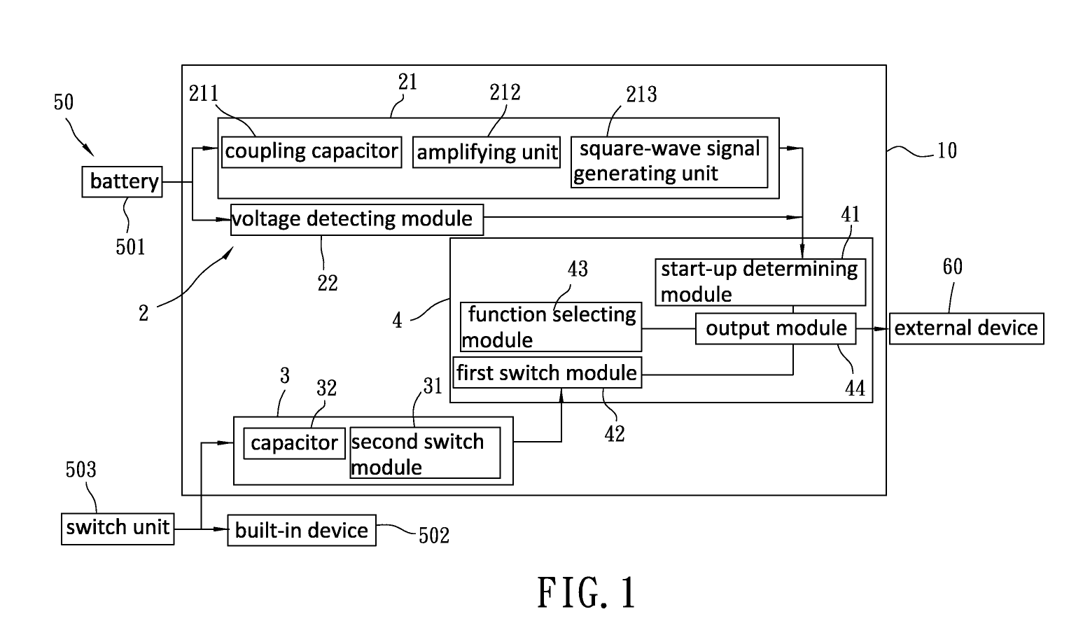

FIG. 1 shows the preferred embodiment of an apparatus 10 for detecting start-up of a vehicle 50 and for controlling an external device 60 according to this invention. The apparatus 10 is to be mounted to the vehicle 50 and to be electrically connected to the external device 60. The vehicle 50 includes a chargeable battery 501, a built-in device 502, and a switch unit 503 that is electrically connected to the built-in device 502 and that is operable to switch on the built-in device 502. In this embodiment, the external device 60 is a daytime running light module, and the built-in device 502 of the vehicle 50 is a positioning light module.

The apparatus 10 of this embodiment includes a detecting unit 2, a voltage regulating unit 3, and a control unit 4. The detecting unit 2 is adapted to be electrically connected to the battery 501 of the vehicle 50 for obtaining information associated with a voltage of the battery 501. The voltage regulating unit 3 is adapted to be electrically connected to the switch unit 503 of the vehicle 50. The control unit 4 is electrically connected to the detecting unit 2 and the voltage regulating unit 3, and is adapted to be electrically connected to the external device 60. The control unit 4 is configured to determine whether the vehicle 50 has started up with reference to the information obtained by the detecting unit 2, and to generate a working signal for triggering the external device 60 upon detecting that the vehicle 50 has started up.

Further, in this embodiment, the apparatus 10 is electrically connected to the battery 501 and the switch unit 503 through three conductive wires (not shown), and electrically connected to the external device 60 through two connection terminals (not shown). Moreover, the apparatus 10 of this embodiment is capable of operating under a basic mode or a function selecting mode depending on the connection of the apparatus 10 with the vehicle 50.

In this embodiment, the detecting unit 2 is adapted to be electrically connected to an anode of the battery 501 for obtaining the information associated with the voltage of the battery 501. Specifically, the detecting unit 2 includes a ripple detecting module 21 and a voltage detecting module 22. The ripple detecting module 21 is adapted to be electrically connected between the battery 501 and the control unit 4 for detecting a ripple in the voltage of the battery 501. The voltage detecting module 22 is adapted to be electrically connected between the battery 501 and the control unit 4 for detecting a magnitude of the voltage of the battery 501.

The ripple detecting module 21 includes a coupling capacitor 211, an amplifying unit 212, and a square-wave signal generating unit 213. The coupling capacitor 211 is adapted to be electrically connected to the battery 501 of the vehicle 50 for filtering a direct current (DC) component of the voltage of the battery 501 so as to generate an alternating current (AC) signal. The amplifying unit 212 is electrically connected to the coupling capacitor 211 for amplifying the AC signal into an amplified signal. The square-wave signal generating unit 213 is electrically connected to the amplifying unit 212 and the control unit 4 for generating a square-wave signal from the amplified signal and outputting the square-wave signal to the control unit 4. The control unit 4 may determine whether the vehicle 50 has started up with reference to the square-wave signal. The square-wave signal is high when the amplified signal is greater than a predetermined voltage, and is low when the amplified signal is smaller than the predetermined voltage. In this embodiment, the amplifying unit 212 is implemented by an operational amplifier circuit while the square-wave signal generating unit 213 is implemented by a comparator circuit, and the predetermined voltage is 0.2 volt. It should be noted that implementation of the amplifying unit 212 and the square-wave signal generating unit 213, and the predetermined voltage are not limited to those disclosed above, and can be modified depending on the application. The amplitude of the square-wave signal can be modified through varying the bias of the comparator circuit.

The voltage detecting module 22 is capable of detecting a magnitude of the voltage of the battery 501. The control unit 4 determines whether the vehicle 50 has started up with reference to at least one of the amplitude of the ripple as detected by the ripple detecting module 21 and the magnitude of the voltage as detected by the voltage detecting module 22. In this embodiment, the voltage detecting module 22 is in the form of a division circuit implemented by a resistor and a Zener diode.

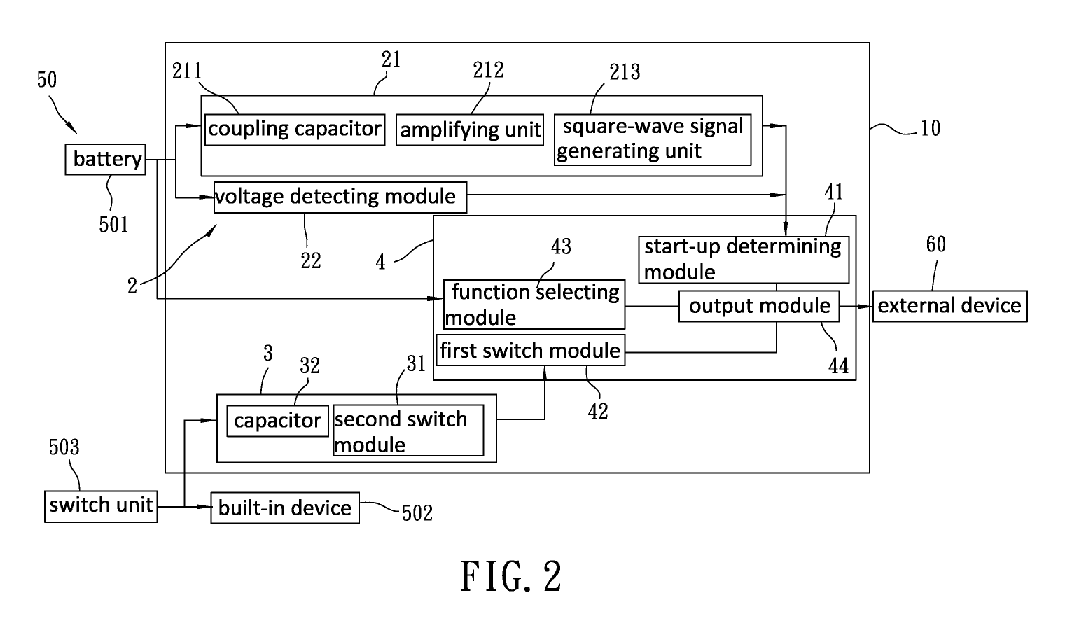

The control unit 4 includes a start-up determining module 41, a first switch module 42, a function selecting module 43, and an output module 44. The start-up determining module 41 is electrically connected to the ripple detecting module 21 and the voltage detecting module 22 of the detecting unit 2. The start-up determining module 41 is capable of determining that the vehicle 50 has started up upon determining, with reference to the information obtained by the detecting unit, i.e., the amplitude of the ripple as detected by the ripple detecting module 21 and the magnitude of the voltage as detected by the voltage detecting module 22, that the voltage of the battery 501 falls within a predetermined range in this embodiment. The first switch module 42 is electrically connected between the voltage regulating unit 3 and the output module 44. The first switch module 42 is switched on by the voltage regulating unit 3 and subsequently controls the output module 44 as will be explained later. The function selecting module 43 determines the operation mode of the apparatus 10 depending on a connection thereof with the battery 501 of the vehicle 50, and is electrically connected to the output module 44 for controlling the output module 44 based on the operation mode. As shown in FIG. 1, when the function selecting module 43 is not connected to the battery 501 of the vehicle, the function selecting module 43 determines that the apparatus 10 operates under a basic mode, and as shown in FIG. 2, when the function selecting module 43 is electrically connected to an anode of the battery 501 of the vehicle 50, the function selecting module 43 determines that the apparatus 10 operates under a function selecting mode. The output module 44 is electrically connected to the start-up determining module 41 and generates the working signal to turn on the external device 60 when the start-up determining module 41 determines that the vehicle 50 has started.

The voltage regulating unit 3 is triggered when the switch unit 503 of the vehicle 50 switches on the built-in device 502 of the vehicle 50 to generate, after a period of delay, a control signal to the first switch module 42 of the control unit 4 so as for the first switch module 41 to control the output module 44 of the control unit 4 to cease generating the working signal so as to turn off the external device 60. In this embodiment, the voltage regulating unit 3 is electrically connected to the switch unit 503 through a conductive wire, and includes a second switch module 31 and a capacitor 32. The second switch module 31 is electrically connected to the first switch module 42 for outputting the control signal thereto. The capacitor 32 is electrically connected between the second switch module 31 and the switch unit 503 for providing the period of delay. The capacitor 32 is charged and subsequently switches on the second switch module 31 for outputting the control signal to the first switch module 42 of the control unit 4 when the switch unit 503 switches on the built-in device 502 so that the output module 44 ceases generating the working signal and that the external device 60 is turned off. When the switch unit 503 switches off the built-in device 502, the capacitor 32 continues to discharge for a period of time, i.e., substantially equal to the period of delay, and subsequently switches off the second switch module 31 so that the second switch module 31 ceases to output the control signal to the first switch module 42, in order for the output module 44 to generate the working signal and for the external device 60 to be turned on again after the period of delay. In this embodiment, the second switch module 31 is a transistor that has a gate electrically connected to the capacitor 32.

When the apparatus 10 operates under the basic mode, the function selecting module 43 remains in a low voltage state, and the detecting unit 2 and the control unit 4 continues to operate, i.e., the information associated with the voltage of the battery 501 is continuously transmitted to the control unit 4. The battery 501 is not charged by an engine when the vehicle 50 has not started up. Therefore, no ripple in the voltage of the battery 501 is detected by the ripple detecting module 21 of the detecting unit 2. In addition, when the vehicle 50 has not started up, the magnitude of the voltage of the battery 501 is around 12 volts. In this embodiment, the voltage detecting module 22 of the detecting unit 2 steps down the terminal voltage by 11 volts, and outputs about 1 volt to the start-up determining module 41 of the control unit 4 for the start-up determining module 41 to determine whether the voltage of the battery 501 falls within the predetermined range. In this embodiment, the start-up determining module 41 compares the output of the voltage detecting module 22 with a predetermined threshold of 2 volts. When the output of the voltage detecting module 22 is smaller than the predetermined voltage, the start-up determining module 41 determines that the vehicle 50 has not started up, and the output module 44 does not generate the working signal. As a result, the external device 60 is not turned on. In other words, the daytime running light is turned off when the vehicle 50 is not started.

When the vehicle 50 has started up, the battery 501 is charged up by the engine and ripples are generated in the voltage so that the ripple detecting module 21 generates a square-wave voltage signal with an amplitude of 5 volts. At the same time, the magnitude of the voltage of the battery 501 is risen from 12 volts to about 13 volts so that the voltage detecting module 22 outputs about 2 volts after stepping down the 13 volts by 11 volts. In this case, the start-up determining module 41 determines that the voltage of the battery 501 falls within the predetermined range with reference to the 5 volts of amplitude in the ripple and the output of 2 volts from the voltage detecting unit 22, which leads to a determination that the vehicle 50 has started up, in turn triggering the output module 44 to generate the working signal to trigger the external device 60. In other words, the daytime running light is now turned on. Thereupon, if a user operates the switch unit 503 to switch on the built-in device 502, i.e., the positioning light module in this embodiment, the voltage regulating module 3 is triggered to generate the control signal, after a period of delay, to the first switch module 42. Simultaneously, the function selecting module 43 determines that the apparatus 10 operates under the basic mode depending on the non-connection thereof with the battery 501, and is in the low voltage state. Accordingly, the output module 44 is controlled by the control signal while the apparatus 10 operates under the basic mode to cease generating the working signal, so that the external device 60 is turned off. Due to the period of delay as created by the discharge of the capacitor 32, the noise interference is prevented and operation of the apparatus 10 is stabilized.

FIG. 2 shows the apparatus 10 operating under the function selecting mode due to the connection between the function selecting module 43 and the battery 501, in which the function selecting module 43 is in a high voltage state. When the vehicle 50 has started up and the apparatus 10 operates under the function selecting mode, if the user operates the switch unit 503 to switch on the built-in device 502, the output module 44 is controlled by the control signal to adjust the working signal such that the external device 60, i.e., the daytime running light, reduces the brightness of its illumination.

To sum up, the external device 60 is automatically switched on when the vehicle 50 starts up. Therefore, when the external device 60 is a daytime running light, the present invention prevents the driver from violating the regulations due to unintentional negligence. Further, the daytime running light is switched off or the brightness of its illumination is reduced when built-in device 502, i.e., the positioning light, is switched on. Therefore, the electric energy can be saved while illumination is maintained. Moreover, the apparatus 10 is directly and electrically connected to the battery 501 so that assembling the apparatus 10 to the vehicle 50 is easy and convenient. In addition, the voltage regulating unit 3 can be implemented to reduce noise.

It should be noted that the external device 60 and the built-in device 502 are not limited to the lighting modules as disclosed herein, and may be replaced by other electronic devices that need to be turned on or turned off when the vehicle 50 starts. Further, the predetermined range for the start-up determining module 41 of the control unit 4 may vary depending on the type of the vehicle 50 and its components.

While the present invention has been described in connection with what is considered the most practical and preferred embodiment, it is understood that this invention is not limited to the disclosed embodiment but is intended to cover various arrangements included within the spirit and scope of the broadest interpretation and equivalent arrangements.

What is claimed is:

1. An apparatus for detecting start-up of a vehicle and for controlling an external device, the apparatus being adapted to be electrically connected between a battery of the vehicle and the external device, and comprising:
a detecting unit that is adapted to be electrically connected to the battery of the vehicle for obtaining information associated with a voltage of the battery; and
a control unit that is adapted to be electrically connected between said detecting unit and the external device, and that is configured to determine whether the vehicle has started up with reference to the information obtained by said detecting unit, and to generate a working signal for triggering the external device upon detecting that the vehicle has started up.

2. The apparatus as claimed in claim 1, wherein said detecting unit includes a ripple detecting module that is adapted to be electrically connected between the battery of the vehicle and said control unit, and that is capable of detecting a ripple in the voltage of the battery, said control unit determining whether the vehicle has started up with reference to an amplitude of the ripple as detected by said ripple detecting unit.

3. The apparatus as claimed in claim 2, wherein said ripple detecting module includes a coupling capacitor that is adapted to be electrically connected to the battery of the vehicle for filtering a direct current (DC) component of the voltage of the battery so as to generate an alternating current (AC) signal, an amplifying unit that is electrically connected to said coupling capacitor for amplifying the AC signal into an amplified signal, and a square-wave signal generating unit that is electrically connected to said amplifying unit and said control unit for generating a square-wave signal from the amplified signal and outputting the square-wave signal to said control unit, said control unit to determining whether the vehicle has started up with reference to the square-wave signal.

4. The apparatus as claimed in claim 2, wherein said detecting unit further includes a voltage detecting module that is adapted to be electrically connected between the battery of the vehicle and said control unit, and that is capable of detecting a magnitude of the voltage of the battery, said control unit determining whether the vehicle has started up with reference to at least one of the amplitude of the ripple as detected by said ripple detecting module and the magnitude of the voltage as detected by said voltage detecting module.

5. The apparatus as claimed in claim 1, wherein said detecting unit includes a voltage detecting module that is adapted to be electrically connected between the battery of the vehicle and said control unit, and that is capable of detecting a magnitude of the voltage of the battery, said control unit determining whether the vehicle has started up with reference to the magnitude of the voltage as detected by said voltage detecting module.

6. The apparatus as claimed in claim 1, wherein said control unit includes a start-up determining module that is electrically connected to said detecting unit, and that is capable of determining that the vehicle has started up upon determining, with reference to the information obtained by said detecting unit, that the voltage of the battery falls within a predetermined range, and an output module that is electrically connected to said start-up determining module and that generates the working signal when said start-up determining module determines that the vehicle has started up.

7. The apparatus as claimed in claim 6, the vehicle further including a built-in device and a switch unit that is electrically connected to the built-in device and that is operable to switch on the built-in device, the apparatus further comprising:
a voltage regulating unit that is adapted to be electrically connected to the switch unit, said control unit further including a first switch module that is electrically connected between said voltage regulating unit and said output module, said voltage regulating unit being triggered when the switch unit of the vehicle switches on the built-in device to generate, after a period of delay, a control signal to said first switch module so as for said first switch module to control said output module to cease generating the working signal.

8. The apparatus as claimed in claim 7, wherein said voltage regulating unit includes a second switch module that is electrically connected to said first switch module for outputting the control signal thereto, and a capacitor that is electrically connected between said second switch module and the switch unit of the vehicle for providing the period of delay.
